(19) United States
(12) Patent Application Publication
(10) Pub. No.: US 2010/0020562 A1
(43) Pub. Date: Jan. 28, 2010

(54) Light system

(76) Inventor: John L. Donoghue, Glenview, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/220,117

(22) Filed: Jul. 22, 2008

(51) Int. Cl. B60Q 1/26

(52) U.S. Cl. 362/541

(57) ABSTRACT

A vehicle may include a tail light and a brake light. The tail light may be used at night or in other low light or low visibility conditions to indicate the presence of the lead vehicle to a vehicle or a person traveling behind the lead vehicle. The brake light may be used to indicate that the brakes are being applied to the lead vehicle. The brake light may be a shade of red in color. The tail light may be a different color than the brake light. For example, the tail light may be blue, green, purple, brown, shades of these colors, or variations of these colors. The tail light is a different color to distinguish the lighted state of the tail light from the activation of the brake light.

### BACKGROUND

During hours of darkness or in low visibility, it is necessary to send an indication to a following vehicle concerning the presence of the vehicles in front of the driver. A tail light may be used to indicate the presence of the lead vehicles. The tail light has a color which is a shade of red. In addition, a vehicle will include a brake light to indicate that a lead vehicle has applied its brakes and allows the following vehicle to reduce its speed and/or apply its brakes. The brake light has a color which is a shade of red. When the brake pedal is depressed, the brake pedal activates the brake light. The brake light has an intensity or brilliance which is greater than the tail light. The principal of this concept is that the change in brilliance or light intensity will alert the following driver that the forward leading vehicle has applied its brakes. The problem with this brake light and tail light combination is that if a following driver's attention is diverted for any reason at the time the brake pedal is applied, the following driver may not sense the change in intensity of the brake light. Thus, by not sensing the change of intensity, a rear end collision may result. The problem is also due to fact that the brake light and the tail light have the same color. The brake light and the tail light differ only in intensity.

In addition, if the lens of the brake light is dirty, then the intensity will be diminished. A dirty brake light may have less intensity than a clean tail light. Thus, a user may not be able to determine that the brake light has been activated.

Also, drivers may become inattentive either due to fatigue, the effects of sleep apnea, the mesmerizing effects of driving for several hours without a break, or other reasons. The activation of the brake light may not overcome the driver's inattention since the driver may not notice the difference in intensity.

### BRIEF SUMMARY

A vehicle may include a tail light and a brake light. The tail light may be used at night or in other low light or low visibility conditions to indicate the presence of the lead vehicle to a vehicle or a person traveling behind the lead vehicle. The brake light may be used to indicate that the brakes are being applied to the lead vehicle. The brake light may be a shade of red in color. The tail light may be a different color than the brake light to more clearly differentiate the purposes of the two lights. For example, the tail light may be blue, green, purple, brown, shades of these colors or variations of these colors. The tail light is a different color to distinguish the lighted state of the tail light from the activation of the brake light.

For example, a vehicle driving on a roadway at night following other vehicles, which are traveling at approximately the same speed, would see only a series of blue lights. When the driver of a leading vehicle applies the brakes, a red light is displayed by the brake light. The red brake light would be in contrast to the blue tail lights. This notifies the driver of the following vehicle of the changed condition of the leading vehicle. Thus, there would be a very distinct and clear separation of the information provided to the following driver. This arrangement may overcome driver inattention due to fatigue, effects of sleep apnea or the mesmerizing effects of driving for several hours without a break. In addition, this arrangement would overcome the effects of a dirty red brake light which may have less intensity than a clean red tail light. Also, this arrangement may overcome a following driver's inattention due to a diversion at the time the brake pedal was applied so that the following driver does not need to sense the change in intensity of the red brake light.

The tail light and brake light may have a horizontal configuration or a vertical configuration. The rear of the vehicle may have other lights, such as, a turn signal light, a back-up or reversing light, or a center brake light. The other lights may be arranged in a horizontal configuration, a vertical configuration or a combination thereof.

### BRIEF DESCRIPTION OF THE DRAWINGS

FIG. 1 is a rear view of a vehicle with a light system.

FIG. 2 is a rear view of another embodiment of a light system.

FIG. 3 is a rear view of another embodiment of a light system.

FIG. 4 is a rear view of another embodiment of a light system.

FIG. 5 is a rear view of another embodiment of a light system.

FIG. 6 is a rear view of another embodiment of a light system.

FIG. 7 is a schematic of an electrical circuit for a light system.

### DESCRIPTION

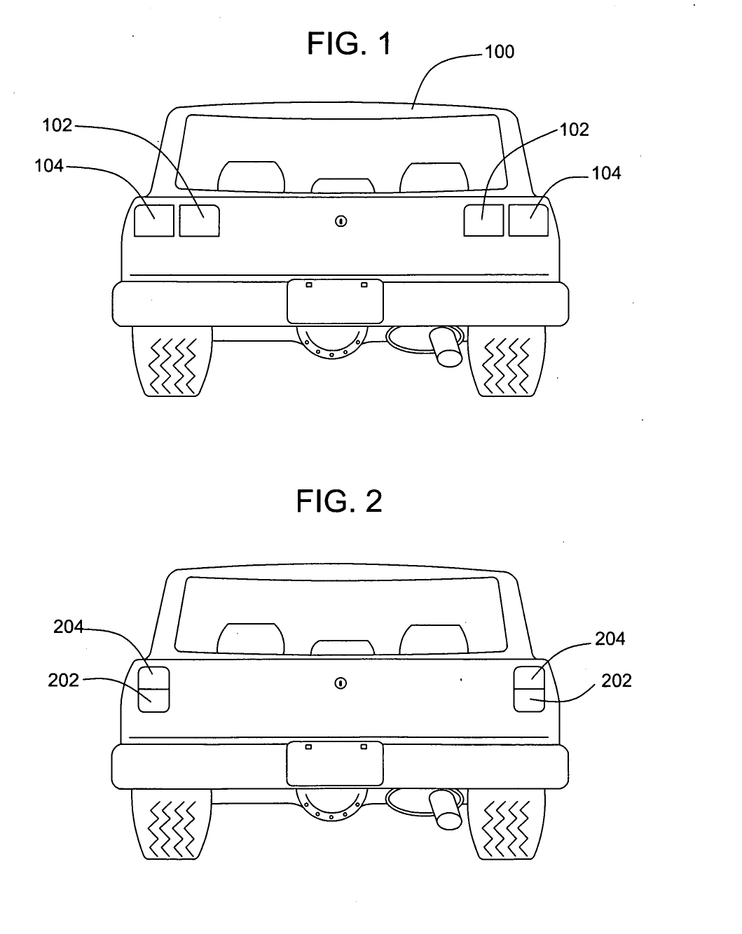

Referring to FIG. 1, a vehicle 100 may include a light 102 and a light 104. The term vehicle may include cars, trucks, trailers, motorcycles, motor scooters, powered wheelchairs, or other vehicles. The light 102 may be a tail light and the light 104 may be a brake light. The tail light 102 may be used at night or in other low light or low visibility conditions to indicate the presence of the lead vehicle to a vehicle or a person traveling behind the lead vehicle. The brake light 104 may be used to indicate that the brakes are being applied to the lead vehicle. When the brake light is activated, a vehicle or person traveling behind the lead vehicle would take appropriate action, such as, applying their brakes and/or reducing their speed. The brake light 104 may be a shade of red in color. The brake light 104 may include a lens and a bulb. The lens may be a shade of red and/or the bulb may be a shade of red.

The tail light 102 may be a different color than the brake light 104. For example, the tail light may be blue, green, purple, brown, shades of these colors, or variations of these colors. The tail light is a different color to distinguish the lighted state of the tail light from the activation of the brake light.

For example, a vehicle driving on a roadway at night following other vehicles, which are traveling at approximately the same speed, would see only a series of blue lights. When the driver of a leading vehicle applies the brakes, a red light is displayed by the brake light. The red brake light would be in contrast to the blue tail lights. This notifies the driver of the following vehicle of the changed condition of the leading vehicle. The following driver is alerted to be ready to apply the necessary braking action of his vehicle. Thus, there would be a very distinct and clear separation of the information provided to the following driver. This arrangement may overcome driver inattention due to fatigue, effects of sleep apnea or the mesmerizing effects of driving for several hours without a break. In addition, this arrangement would overcome the effects of a dirty red brake light which may have less intensity than a clean red tail light. Also, this arrangement may overcome a following driver's inattention due to a diversion at the time the brake pedal was applied so that the following driver does not need to sense the change in intensity of the red brake light. The following driver will see the color red for the first time.

Referring to FIG. 1, the tail light and brake light may have a horizontal configuration. For example, the tail light may be adjacent the brake light. In one embodiment, the brake light may be the light 104 in the outer position and the tail light may be the light 102 in the inner position. In another embodiment, the tail light may be the light 104 in the outer position and the brake light may be the light 102 in the inner position.

Referring to FIG. 2, the tail light and brake light may have a vertical configuration. For example, the tail light may be above or below the brake light. In one embodiment, the brake light may be the light 204 in the upper position and the tail light may be the light 202 in the lower position. In another embodiment, the brake light may be the light 202 in the lower position and the tail light may be the light 204 in the upper position. The tail light may be a different color, as noted herein, than the brake light.

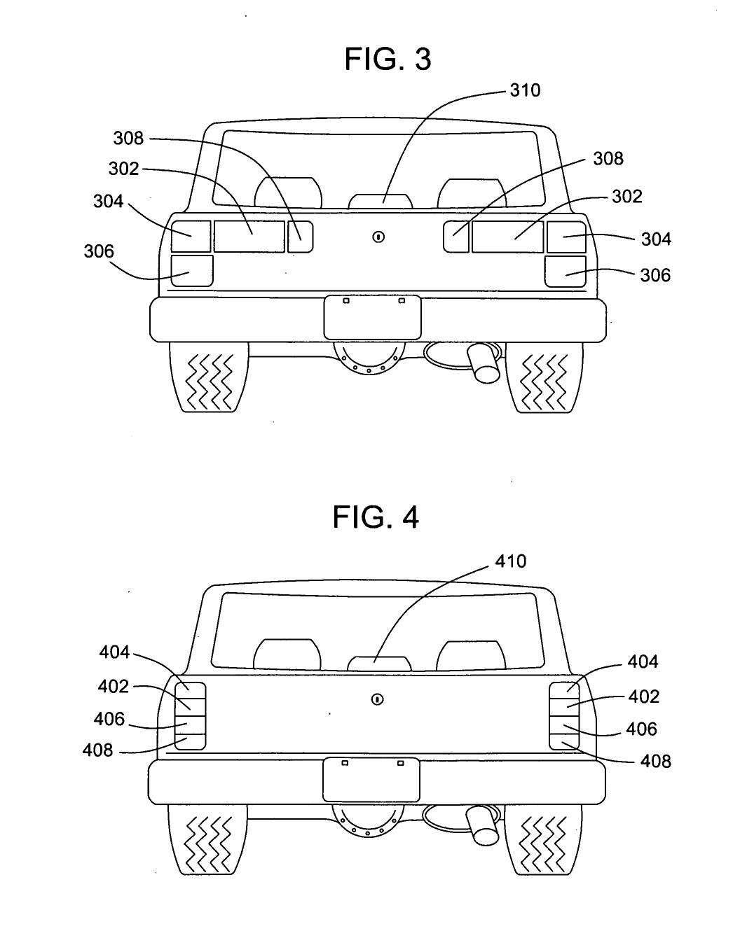

Referring to FIG. 3, the rear of the vehicle may have other lights, such as, a turn signal light 306, a back-up or reversing light 308, or a center brake light 310. In one embodiment, the tail light 302 may be a different color, as noted herein, than the brake light 304, the turn signal light 306, the backup light 308 and the center brake light 310. The other lights may be arranged in a horizontal configuration, a vertical configuration or a combination thereof. For example, FIG. 4 illustrates a vertical configuration with a tail light 402, a brake light 404, a turn signal light 406 and a backup light 408. The tail light 402 may be a different color, as noted herein, than the brake light 404, the turn signal light 406, the backup light 408 and the center brake light 410.

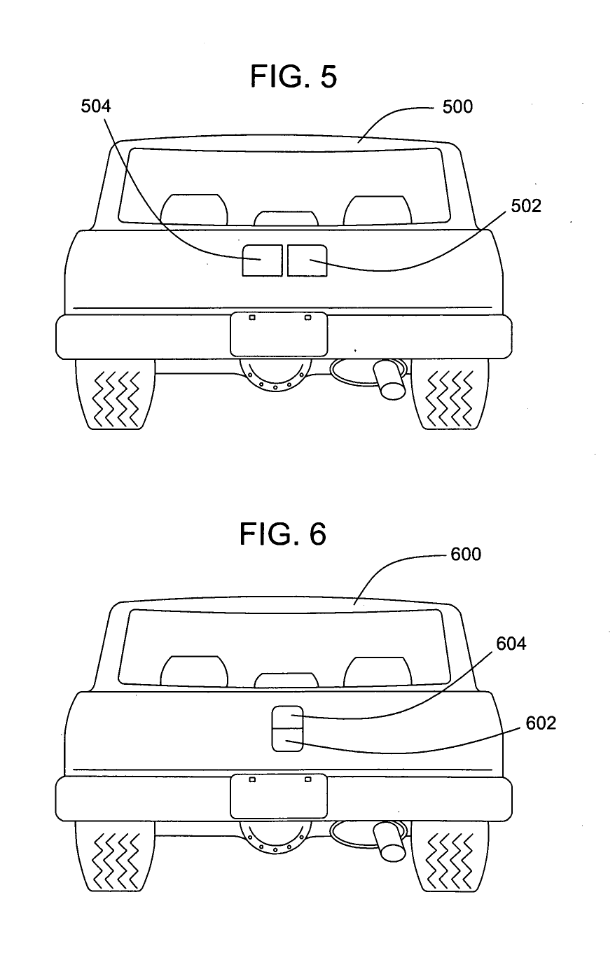

FIG. 5 shows another embodiment of a light system. The vehicle 500 may include a center light 502 and a center light 504. In one embodiment, the center light 502 may be a tail light and the center light 504 may be a brake light. In another embodiment, the center light 502 may be a brake light and the center light 504 may be a tail light. The tail light may be a different color, as noted herein, than the brake light. In other embodiments, the vehicle may include other lights, such as a turn signal light, a backup light, and/or an upper center brake light, as noted herein.

FIG. 6 shows another embodiment of a light system. This light system is similar to the light system in FIG. 5 except that the light 602 is in a vertical configuration with respect to the light 604. In one embodiment, the light 602 may be the tail light and the light 604 may be the brake light. In another embodiment, the light 602 may be the brake light and the light 604 may be the tail light. The tail light may be a different color, as noted herein, than the brake light. In other embodiments, the vehicle may include other lights, such as a turn signal light, a backup light, and/or an upper center brake light, as noted herein.

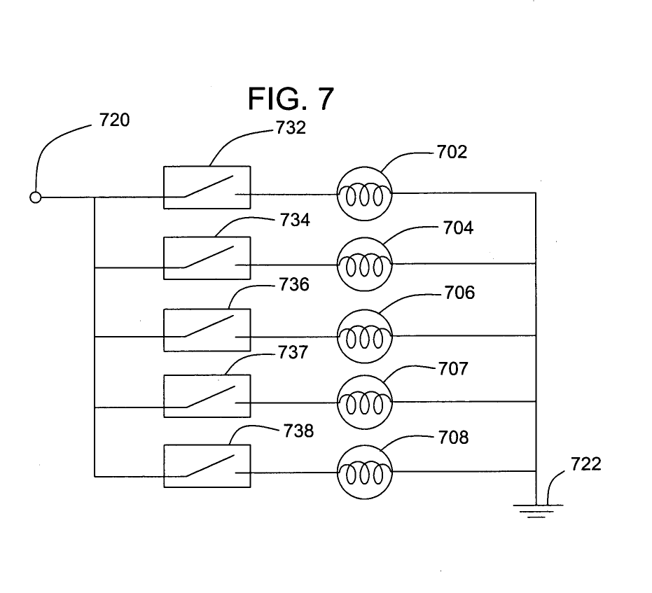

FIG. 7 shows a schematic electrical circuit for the lights. The lights may include a tail light 702, a brake light 704, a right turn signal light 706, a left turn signal light 707, and a backup light 708. The lights may be powered by an electrical source 720, such as, a battery or an alternator. The lights may be connected to a ground 722. The lights may be connected to switches which activate and deactivate the lights. The tail light switch 732 may be connected to the tail light or head light control. The brake switch 734 may be connected to the brake pedal. The turn signal switches 736, 737 may be connected to the turn signal control and the backup switch 738 may be connected to the gear selector. When a switch is closed, the electrical current from the battery provides energy to the corresponding light.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A light system for a vehicle comprising a brake light for attachment to a rear portion of a vehicle, the brake light is activated when a user applies the brakes, the brake light has a first color, the first color is a shade of red, a tail light for attachment to a rear portion of a vehicle, the tail light is activated when a user activates the tail light, the tail light has a second color, the second color is a different color than the first color.

2. The light system as in claim 1 wherein the second color is selected from the group consisting of blue, green, purple, brown, shades of these colors, and variations of these colors.

3. The light system as in claim 1 wherein the tail light includes a lens with the second color.

4. The light system as in claim 1 wherein the tail light includes a bulb with the second color.

5. The light system as in claim 1 wherein the tail light and brake light are configured vertically with respect to each other.

6. The light system as in claim 1 wherein the tail light and brake light are configured horizontally with respect to each other.

7. The light system as in claim 1 further comprising a brake switch and a tail light switch.

8. The light system as in claim 1 further comprising a turn signal light and a backup light.

9. A transportation device comprising a vehicle and a light system, the light system including a brake light for attachment to a rear portion of a vehicle, the brake light is activated when a user applies the brakes, the brake light has a first color, the first color is a shade of red, a tail light for attachment to a rear portion of a vehicle, the tail light is activated when a user activates the tail light, the tail light has a second color, the second color is a different color than the first color.

10. The method of using a light system for a vehicle, the light system includes a brake light and a tail light for attachment to a rear portion of a vehicle, the method comprising:
activating the brake light when a user applies the brakes, the brake light has a first color, the first color is a shade of red; and
activating the tail light when a user switches on the tail light, the tail light has a second color, the second color is a different color than the first color.

11. The method as in claim 10 wherein the second color is selected from the group consisting of blue, green, purple, brown, shades of these colors, and variations of these colors.

12. The method as in claim 10 wherein the tail light includes a lens with the second color.

13. The method as in claim 10 wherein the tail light includes a bulb with the second color.

14. The method as in claim 10 wherein the tail light and brake light are configured vertically with respect to each other.

15. The method as in claim 10 wherein the tail light and brake light are configured horizontally with respect to each other.

16. The method as in claim 10 further comprising a brake switch and a tail light switch.

17. The method as in claim 10 further comprising a turn signal light and a backup light.

18. The method as in claim 10 wherein the vehicle is a car.

19. The transportation device as in claim 9 wherein the second color is selected from the group consisting of blue, green, purple, brown, shades of these colors, and variations of these colors.

20. The transportation device as in claim 9 wherein the tail light includes a lens with the second color.

21. The transportation device as in claim 9 wherein the tail light includes a bulb with the second color.

22. The transportation device as in claim 9 wherein the tail light and brake light are configured vertically with respect to each other.

23. The transportation device as in claim 9 wherein the tail light and brake light are configured horizontally with respect to each other.

24. The transportation device as in claim 9 further comprising a brake switch and a tail light switch.

25. The transportation device as in claim 9 further comprising a turn signal light and a backup light.

26. The transportation device as in claim 9 wherein the vehicle is a car.
